(19) United States
(12) Patent Application Publication
(10) Pub. No.: US 2014/0369839 A1
(43) Pub. Date: Dec. 18, 2014

(54) BEARING MECHANISM AND BLOWER FAN

(71) Applicant: NIDEC CORPORATION, Kyoto (JP)

(72) Inventors: Takehito Tamaoka, Kyoto (JP); Kazuhiko Fukushima, Kyoto (JP)

(73) Assignee: NIDEC CORPORATION, Kyoto (JP)

(21) Appl. No.: 14/149,052

(22) Filed: Jan. 7, 2014

(30) Foreign Application Priority Data
Jun. 14, 2013 (JP) 2013-125638

(51) Int. Cl. F04D 29/057; F16C 32/06

(52) U.S. Cl. CPC F04D 29/057; F16C 32/0685
USPC 416/174; 384/114

(57) ABSTRACT

A sleeve housing of a bearing mechanism according to a preferred embodiment of the present invention includes a cylindrical portion arranged to cover outer circumferences of a sleeve and a plate portion, and a bottom portion arranged to close a lower portion of the cylindrical portion. The bottom portion includes a plurality of projecting portions arranged in a circumferential direction in an upper surface of the bottom portion. Each projecting portion is arranged to project upward to be in contact with a lower surface of the sleeve. Each of the projecting portions and the plate portion are arranged radially opposite each other. At least a portion of an adhesive is arranged to exist between an outer circumferential surface of the sleeve and an inner circumferential surface of the cylindrical portion.

### BACKGROUND OF THE INVENTION

1. Field of the Invention

The present invention relates to a bearing mechanism using fluid dynamic pressure. The bearing mechanism is used, for example, in a motor.

2. Description of the Related Art

Some known bearing mechanisms used in motors use fluid dynamic pressure. Such bearing mechanisms are described, for example, in JP-A 2005-282779, JP-A 2008-138713, and JP-A 2008-163969. In each of these bearing mechanisms, a sleeve is accommodated in a sleeve housing. A lubricating oil is held in the sleeve housing. In the case where an adhesive is used to fix the sleeve to the sleeve housing, a structure to avoid interference of the adhesive with a rotating member of the bearing mechanism is demanded.

In the case of the bearing mechanism described in JP-A 2008-138713, for example, an adhesive is filled into an adhesive filling portion after a bearing sleeve is press fitted to a housing. In the case of the bearing mechanism described in JP-A 2008-163969, an annular raised portion is arranged in a lower surface of a sleeve, and this annular raised portion prevents a superfluous adhesive from flowing into a thrust dynamic pressure bearing portion.

In the bearing mechanism disclosed in JP-A 2008-138713, the adhesive filling portion needs to be provided, and this results in an increase in the size of the bearing mechanism. In the bearing mechanism disclosed in JP-A 2008-163969, the adhesive may be held in an annular shape between a lower surface of the sleeve and an opposed annular shoulder portion of a sleeve housing depending on the total amount of the adhesive, and this makes it cumbersome to control the axial position of the sleeve relative to the sleeve housing.

### SUMMARY OF THE INVENTION

A bearing mechanism according to a preferred embodiment of the present invention includes a shaft arranged to have a central axis extending in a vertical direction as a center thereof; a sleeve in which the shaft is inserted; a plate portion in a shape of a disk, arranged to extend radially outward from a lower end of the shaft, arranged opposite to a lower surface of the sleeve, and arranged to have a diameter smaller than that of the lower surface of the sleeve; a sleeve housing inside which the sleeve and the plate portion are arranged; an adhesive arranged to adhere the sleeve and the sleeve housing to each other; and a lubricating oil. The sleeve housing includes a cylindrical portion arranged to cover outer circumferences of the sleeve and the plate portion, and a bottom portion arranged to close a lower portion of the cylindrical portion. The bottom portion includes a plurality of projecting portions arranged in a circumferential direction in an upper surface of the bottom portion, each projecting portion being arranged to project upward to be in contact with the lower surface of the sleeve. Each of the projecting portions and the plate portion are arranged radially opposite each other. At least a portion of the adhesive is arranged to exist between an outer circumferential surface of the sleeve and an inner circumferential surface of the cylindrical portion. The lubricating oil is arranged to exist continuously in a gap between a portion including the sleeve and the sleeve housing and a portion including the shaft and the plate portion. The shaft and the sleeve are arranged to have a radial dynamic pressure bearing portion defined therebetween.

The present invention is able to easily achieve a reduction in a decrease in accuracy of the axial position of the sleeve relative to the sleeve housing.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a vertical cross-sectional view of a blower fan according to a preferred embodiment of the present invention.

FIG. 2 is a vertical cross-sectional view of a motor portion and its vicinity according to the above preferred embodiment.

FIG. 3 is a vertical cross-sectional view of a sleeve according to the above preferred embodiment.

FIG. 4 is a plan view of the sleeve.

FIG. 5 is a bottom view of the sleeve.

FIG. 6 is a vertical cross-sectional view of a bearing portion and its vicinity according to the above preferred embodiment.

FIG. 7 is a perspective view of a sleeve housing according to the above preferred embodiment.

FIG. 8 is a plan view of the sleeve housing.

FIG. 9 is a vertical cross-sectional view of the sleeve housing.

FIG. 10 is a vertical cross-sectional view of a shoulder portion according to an example modification of the above preferred embodiment.

FIG. 11 is a vertical cross-sectional view of a sleeve housing according to an example modification of the above preferred embodiment.

FIG. 12 is a plan view of a sleeve housing according to another example modification of the above preferred embodiment.

FIG. 13 is a perspective view of a sleeve housing according to yet another example modification of the above preferred embodiment.

FIG. 14 is a plan view of the sleeve housing illustrated in FIG. 13.

FIG. 15 is a vertical cross-sectional view of a bearing mechanism according to an example modification of the above preferred embodiment.

### DETAILED DESCRIPTION OF THE PREFERRED EMBODIMENTS

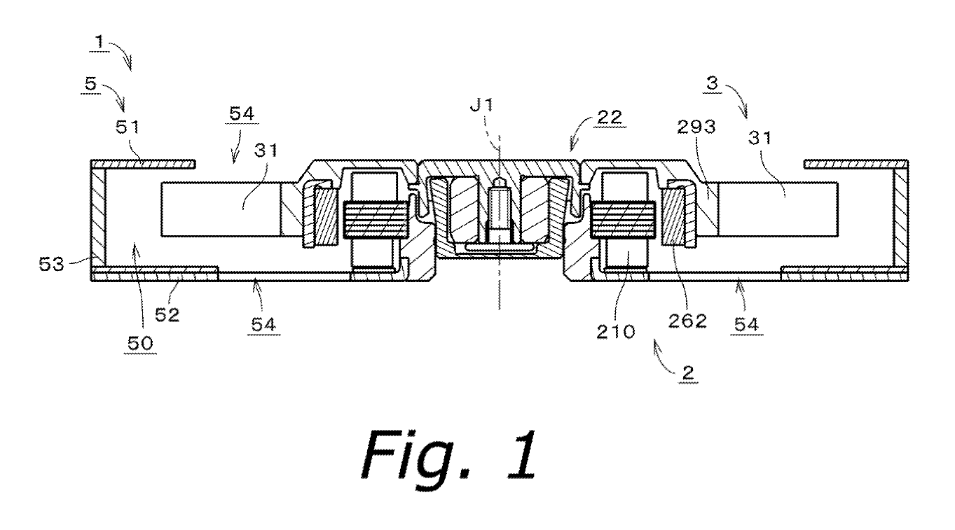

It is assumed herein that an upper side and a lower side in a direction parallel to a central axis J1 of a blower fan 1 illustrated in FIG. 1 are referred to simply as an upper side and a lower side, respectively. Note that a vertical direction assumed herein may not necessarily correspond with a vertical direction of the blower fan 1 when the blower fan 1 is actually installed in a device. It is also assumed herein that a circumferential direction about the central axis J1 is simply referred to by the term “circumferential direction”, “circumferential”, or “circumferentially”, that radial directions centered on the central axis J1 are simply referred to by the term “radial direction”, “radial”, or “radially”, and that the direction parallel to the central axis J1 is simply referred to by the term “axial direction”, “axial”, or “axially”.

FIG. 1 is a vertical cross-sectional view of the blower fan 1 according to a preferred embodiment of the present invention. The blower fan 1 is a centrifugal fan. The blower fan 1 is, for example, installed in a notebook personal computer, and is used to cool devices inside a case of the computer.

The blower fan 1 includes a motor portion 2, an impeller 3, and a housing 5. A central axis of the impeller 3 coincides with the central axis J1 of the motor portion 2. The impeller 3 includes a plurality of blades 31. The blades 31 are arranged in a circumferential direction about the central axis J1. The motor portion 2 is arranged to rotate the blades 31 about the central axis J1. The housing 5 is arranged to accommodate the motor portion 2 and the impeller 3.

The housing 5 includes an upper plate 51, a lower plate 52, and a side wall portion 53. The upper plate 51 is arranged to cover an upper side of the blades 31. The lower plate 52 is arranged to cover a lower side of the blades 31. The motor portion 2 is fixed to the lower plate 52. The side wall portion 53 is arranged to cover a lateral side of the blades 31. The upper plate 51, the side wall portion 53, and the lower plate 52 are arranged to together define an air channel portion 50 arranged to surround the impeller 3.

Each of the upper and lower plates 51 and 52 is made of a metal, such as an aluminum alloy or stainless steel, and is defined in the shape of a thin plate. The side wall portion 53 is made of an aluminum alloy, and is molded by die casting. Alternatively, the side wall portion 53 may be molded of a resin. A lower end portion of the side wall portion 53 and an edge portion of the lower plate 52 are joined to each other through screws or the like. The upper plate 51 is fixed to an upper end portion of the side wall portion 53 by crimping or the like. Each of the upper and lower plates 51 and 52 includes an air inlet 54. The air inlets 54 are located above and below the impeller 3. The upper plate 51, the side wall portion 53, and the lower plate 52 are arranged to together define an air outlet on a lateral side of the blades 31. Note that the lower plate 52 is arranged to define a portion of a stationary portion 21, which will be described below, of the motor portion 2.

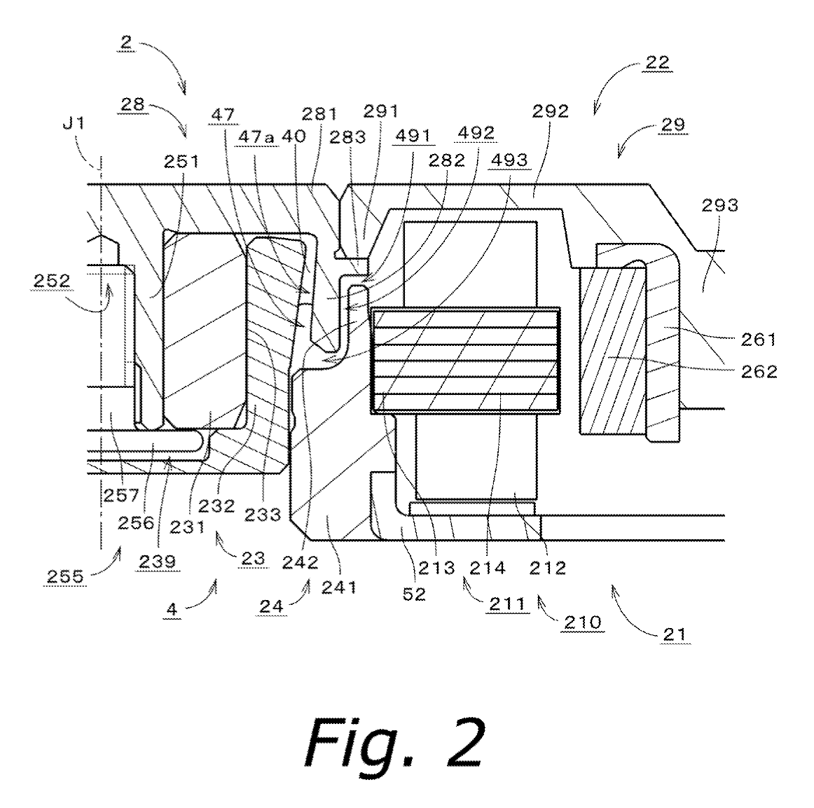

FIG. 2 is a vertical cross-sectional view of the motor portion 2 and its vicinity. The motor portion 2 is of an outer-rotor type. The motor portion 2 includes the stationary portion 21, which is a stationary assembly, and a rotating portion 22, which is a rotating assembly. Since a bearing mechanism 4 is defined by a portion of the stationary portion 21 and a portion of the rotating portion 22 as described below, the motor portion 2 can be considered to include the stationary portion 21, the bearing mechanism 4, and the rotating portion 22 when the bearing mechanism 4 is regarded as a component of the motor portion 2. The rotating portion 22 is supported by the bearing mechanism 4 to be rotatable about the central axis J1 with respect to the stationary portion 21.

The stationary portion 21 includes a stator 210, a bearing portion 23, a bushing 24, and the lower plate 52. The bearing portion 23 has a bottom and is substantially cylindrical and centered on the central axis J1. The bearing portion 23 includes a sleeve 231 and a sleeve housing 232. The sleeve 231 is substantially cylindrical and centered on the central axis J1. The sleeve 231 is a metallic sintered body. The sleeve 231 is impregnated with a lubricating oil 40. An improvement in flexibility in choosing a material of an inner circumferential portion of the bearing portion 23 is achieved by the bearing portion 23 being composed of two components. In addition, an increase in the amount of the lubricating oil 40 held in the bearing portion 23 is easily achieved by the sleeve 231 being a sintered body.

The sleeve housing 232 has a bottom and is substantially cylindrical and centered on the central axis J1. The sleeve housing 232 is arranged to cover an outer circumferential surface and a lower surface of the sleeve 231. The sleeve 231 is fixed to an inner circumferential surface of the sleeve housing 232 through an adhesive 233. The sleeve housing 232 is made of a resin. Preferably, both adhesion and press fit are used to fix the sleeve 231 and the sleeve housing 232 to each other. A radially inner portion of the lower surface of the sleeve 231 is spaced away from an inner bottom surface of the sleeve housing 232 in the vertical direction. The lower surface of the sleeve 231 and the inner circumferential surface and the inner bottom surface of the sleeve housing 232 are arranged to together define a plate accommodating portion 239.

The bushing 24 is a substantially annular member centered on the central axis J1. The bushing 24 is preferably an insulating member. More preferably, the bushing 24 is molded of a resin. The bushing 24 includes a bushing body portion 241 and a bushing projecting portion 242. The bushing body portion 241 and the bushing projecting portion 242 are preferably defined integrally with each other. The bushing body portion 241 is substantially cylindrical and centered on the central axis J1. The bushing projecting portion 242 is also substantially cylindrical and centered on the central axis J1. The bushing projecting portion 242 is arranged to have a radial thickness smaller than that of the bushing body portion 241. The bushing projecting portion 242 is arranged to project upward from an outer periphery portion of an upper surface of the bushing body portion 241.

A lower portion of an outer circumferential surface of the sleeve housing 232 is fixed to an inner circumferential surface of the bushing body portion 241 through an adhesive. Note that both adhesion and press fit may be used to fix the sleeve housing 232 and the bushing 24 to each other. A lower portion of an outer circumferential surface of the bushing 24 is fixed in a hole portion defined in the lower plate 52.

The stator 210 is a substantially annular member centered on the central axis J1. The stator 210 is fixed to the outer circumferential surface of the bushing 24. The stator 210 includes a stator core 211 and a plurality of coils 212. The stator core 211 is defined by laminated silicon steel sheets each of which is in the shape of a thin plate. The stator core 211 includes a substantially annular core back 213 and a plurality of teeth 214 arranged to project radially outward from the core back 213. Each of the coils 212 is defined by a conducting wire wound around a separate one of the teeth 214.

The bushing 24 is press fitted to the core back 213. An inner circumferential surface of the core back 213 is fixed to both an upper portion of an outer circumferential surface of the bushing body portion 241 and a lower portion of an outer circumferential surface of the bushing projecting portion 242. An upper end of the bushing projecting portion 242 is arranged at a level higher than that of an upper end of the core back 213. A large area of contact between the inner circumferential surface of the core back 213 and the outer circumferential surface of the bushing 24 is thereby secured. This results in an increase in strength with which the core back 213 and the bushing 24 are joined to each other. Note that adhesion or slight press fit may be used to fix the core back 213 and the bushing 24 to each other. Also note that both adhesion and press fit may be used to fix the core back 213 and the bushing 24 to each other.

As described above, the bushing 24 is a holding portion arranged to have the stator 210 fixed to an outer circumferential surface thereof and to have the bearing portion 23 fixed to an inner circumferential surface thereof. In the motor portion 2, both the stator 210 and the bearing portion 23 are indirectly fixed to the lower plate 52, which is a base portion, as a result of the bushing 24 being fixed to the lower plate 52.

The rotating portion 22 includes a central rotating portion 28, a coming-off preventing portion 255, a cup portion 29, a yoke 261, and a rotor magnet 262. The central rotating portion 28 is supported by the bearing portion 23. The cup portion 29 is a member separate from the central rotating portion 28. The cup portion 29 is annular and centered on the central axis J1. The cup portion 29 is fixed to the central rotating portion 28 radially outside the central rotating portion 28.

The central rotating portion 28 includes a shaft 251, a bearing opposing portion 281, and a cylindrical seal portion 282. The shaft 251, the bearing opposing portion 281, and the cylindrical seal portion 282 are defined by a single continuous member. The central rotating portion 28 is preferably defined by subjecting a metal to a cutting process.

The shaft 251 is substantially columnar and centered on the central axis J1. The shaft 251 is inserted in the sleeve 231 of the bearing portion 23. In other words, the sleeve 231 is arranged to surround the shaft 251 from radially outside. The shaft 251 is arranged to rotate about the central axis J1 relative to the bearing portion 23.

The coming-off preventing portion 255 is arranged at a lower portion of the shaft 251. The coming-off preventing portion 255 includes a plate portion 256 and a plate fixing portion 257. The plate portion 256 is substantially in the shape of a disk and arranged to extend radially outward from a lower end portion of the shaft 251. The plate portion 256 is arranged to have a diameter smaller than that of the lower surface of the sleeve 231. The plate fixing portion 257 is arranged to extend upward from an upper surface of the plate portion 256. An outer circumferential surface of the plate fixing portion 257 includes a male screw portion defined therein. The shaft 251 includes a hole portion 252 arranged to extend upward from a lower end thereof. An inner circumferential surface of the hole portion 252 includes a female screw portion defined therein. The plate fixing portion 257 is screwed into the hole portion 252, whereby the plate portion 256 is fixed to the lower end portion of the shaft 251.

Both the sleeve 231 and the plate portion 256 are arranged inside the sleeve housing 232. The plate portion 256 is accommodated in the aforementioned plate accommodating portion 239. The upper surface of the plate portion 256 is a substantially annular surface. The upper surface of the plate portion 256 is arranged opposite to the lower surface of the sleeve 231, that is, a downward facing surface in the plate accommodating portion 239, in the vertical direction. The plate portion 256 and the sleeve 231 are arranged to together prevent the shaft 251 from coming off the bearing portion 23. A lower surface of the plate portion 256 is arranged opposite to the inner bottom surface of the sleeve housing 232 in the vertical direction.

The bearing opposing portion 281 is arranged to extend radially outward from an upper end of the shaft 251. The bearing opposing portion 281 is substantially in the shape of an annular plate and centered on the central axis J1. The bearing opposing portion 281 is arranged above the bearing portion 23 and opposite to the bearing portion 23 in the vertical direction. The cylindrical seal portion 282 is substantially cylindrical, and is arranged to extend downward from the bearing opposing portion 281. The cylindrical seal portion 282 is continuous with an outer periphery portion of the bearing opposing portion 281. The cylindrical seal portion 282 is arranged radially outward of the bearing portion 23 and radially inward of the stator 210. An inner circumferential surface of the cylindrical seal portion 282 is arranged radially opposite an upper portion of an outer circumferential surface of the bearing portion 23. A seal gap 47 is defined between the inner circumferential surface of the cylindrical seal portion 282 and the outer circumferential surface of the sleeve housing 232. A seal portion 47a, which has a surface of the lubricating oil 40 defined therein, is defined in the seal gap 47.

The cup portion 29 includes a cup inner wall portion 291, a cup top plate portion 292, and a cup outer wall portion 293. The cup inner wall portion 291, the cup top plate portion 292, and the cup outer wall portion 293 are defined by a single continuous insulating member. The cup portion 29 is preferably made of a resin.

The cup inner wall portion 291 is substantially cylindrical and centered on the central axis J1. The cup top plate portion 292 is arranged to extend radially outward from an upper end portion of the cup inner wall portion 291. The cup top plate portion 292 is substantially in the shape of a disk and centered on the central axis J1. The cup outer wall portion 293 is arranged to extend downward from an outer edge portion of the cup top plate portion 292. The cup outer wall portion 293 is substantially cylindrical and centered on the central axis J1.

An inner circumferential surface of the cup inner wall portion 291 is fixed to an outer circumferential surface of the cylindrical seal portion 282. The central rotating portion 28 is inserted in the cup portion 29. The central rotating portion 28 and the cup portion 29 are fixed to each other through adhesion or both adhesion and press fit. The outer circumferential surface of the cylindrical seal portion 282 includes a raised portion 283 arranged to project radially outward. A lower end of the cup inner wall portion 291 is arranged to be in contact with an upper surface of the raised portion 283.

A lower end portion of the cylindrical seal portion 282 is arranged opposite to the upper surface of the bushing body portion 241 in the vertical direction. The outer circumferential surface of the cylindrical seal portion 282 is arranged radially opposite an inner circumferential surface of the bushing projecting portion 242 below the raised portion 283. The bushing projecting portion 242 is a radially opposing portion arranged radially opposite the cylindrical seal portion 282.

An upper end surface of the bushing projecting portion 242 and a lower surface of the raised portion 283 are arranged opposite to each other in the vertical direction. Both the bushing projecting portion 242 and the cup inner wall portion 291 are arranged radially between the cylindrical seal portion 282 and the stator 210. An annular minute horizontal gap 491 extending radially is defined between the upper end surface of the bushing projecting portion 242 and the lower surface of the raised portion 283. In other words, the bushing projecting portion 242 and the raised portion 283 are arranged opposite to each other in the vertical direction with the horizontal gap 491 intervening therebetween. The vertical dimension of the horizontal gap 491 is preferably arranged in the range of about 0.1 mm to about 0.5 mm.

An annular minute vertical gap 492 extending in the vertical direction is defined between the inner circumferential surface of the bushing projecting portion 242 and the outer circumferential surface of the cylindrical seal portion 282. The vertical gap 492 is continuous with an inner circumferential portion of the horizontal gap 491, and is arranged to extend downward from the horizontal gap 491. An annular minute intermediate gap 493 is defined between the lower end portion of the cylindrical seal portion 282 and the upper surface of the bushing body portion 241. The intermediate gap 493 is continuous with both a lower end portion of the vertical gap 492 and a lower end portion of the seal gap 47. In other words, the intermediate gap 493 is arranged to join the lower end portion of the vertical gap 492 and the lower end portion of the seal gap 47 to each other.

The horizontal gap 491, the vertical gap 492, and the intermediate gap 493 are arranged to together define a labyrinth structure radially outside the seal gap 47. This contributes to preventing an air including the lubricating oil 40 evaporated from the seal gap 47 from traveling out of the bearing mechanism 4. As a result, a reduction in evaporation of the lubricating oil 40 out of the bearing mechanism 4 is achieved. In addition, an increase in the vertical dimension of the labyrinth structure is achieved by the upper end of the bushing projecting portion 242 being arranged at a level higher than that of the upper end of the core back 213.

The yoke 261 is substantially cylindrical and centered on the central axis J1. The yoke 261 is fixed to an inner circumferential surface of the cup outer wall portion 293. The rotor magnet 262 is substantially cylindrical and centered on the central axis J1, and is fixed to an inner circumferential surface of the yoke 261. In other words, the rotor magnet 262 is indirectly fixed to the inner circumferential surface of the cup outer wall portion 293 through the yoke 261. The rotor magnet 262 is arranged radially outside the stator 210.

Referring to FIG. 1, the blades 31 are directly fixed to an outer circumferential surface of the cup outer wall portion 293. Note that the blades 31 may be indirectly fixed to the outer circumferential surface of the cup outer wall portion 293 through another member such as a blade support portion.

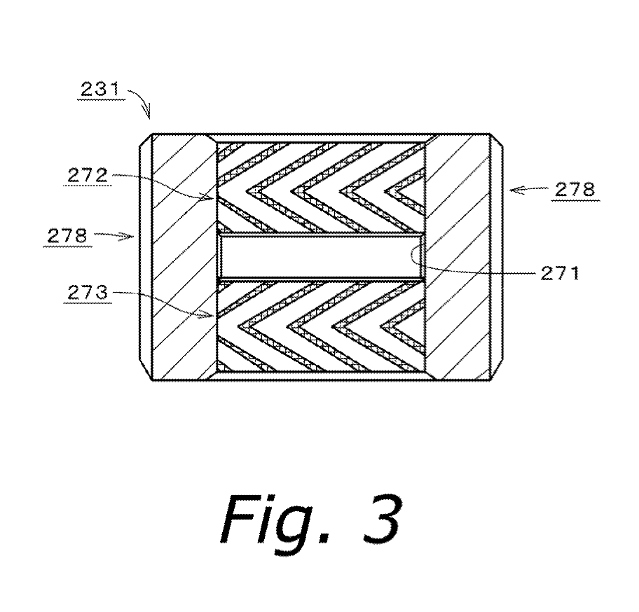

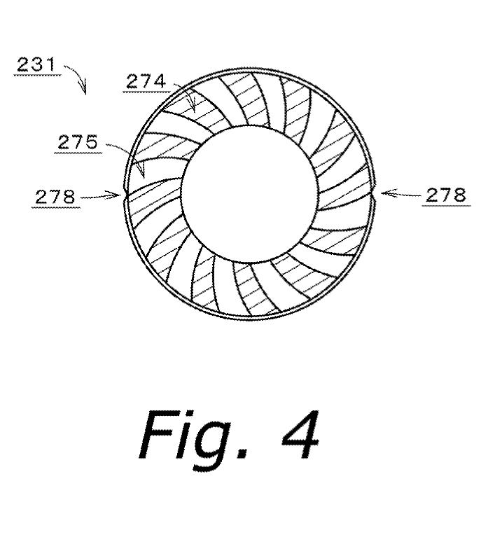

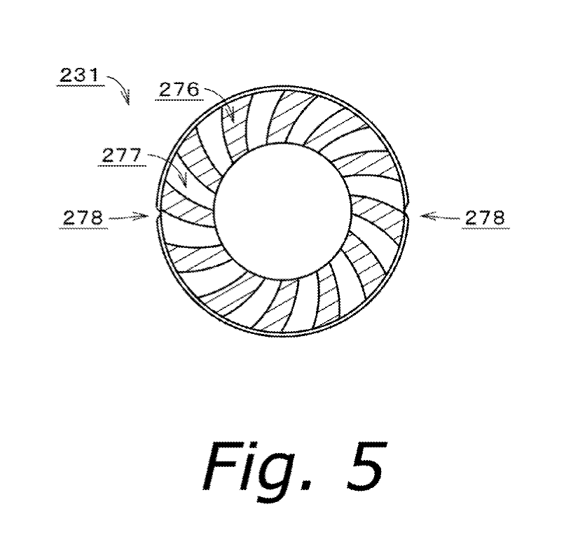

FIG. 3 is a vertical cross-sectional view of the sleeve 231. An upper portion and a lower portion of an inner circumferential surface 271 of the sleeve 231 include a first radial dynamic pressure groove array 272 and a second radial dynamic pressure groove array 273, respectively. Each of the first and second radial dynamic pressure groove arrays 272 and 273 is made up of a plurality of grooves arranged in a herringbone pattern. FIG. 4 is a plan view of the sleeve 231. An upper surface 274 of the sleeve 231 includes a first thrust dynamic pressure groove array 275 made up of a plurality of grooves arranged in a spiral pattern. FIG. 5 is a bottom view of the sleeve 231. A lower surface 276 of the sleeve 231 includes a second thrust dynamic pressure groove array 277 arranged in a spiral pattern.

Note that each of the first and second radial dynamic pressure groove arrays 272 and 273 may be defined in an outer circumferential surface of the shaft 251. Also note that the first thrust dynamic pressure groove array 275 may be defined in a region of a lower surface of the bearing opposing portion 281 which is opposed to the upper surface 274 of the sleeve 231. Also note that the second thrust dynamic pressure groove array 277 may be defined in the upper surface of the plate portion 256. Also note that the first thrust dynamic pressure groove array 275 may be made up of a collection of grooves arranged in a herringbone pattern. Also note that the second thrust dynamic pressure groove array 277 may also be made up of a collection of grooves arranged in a herringbone pattern.

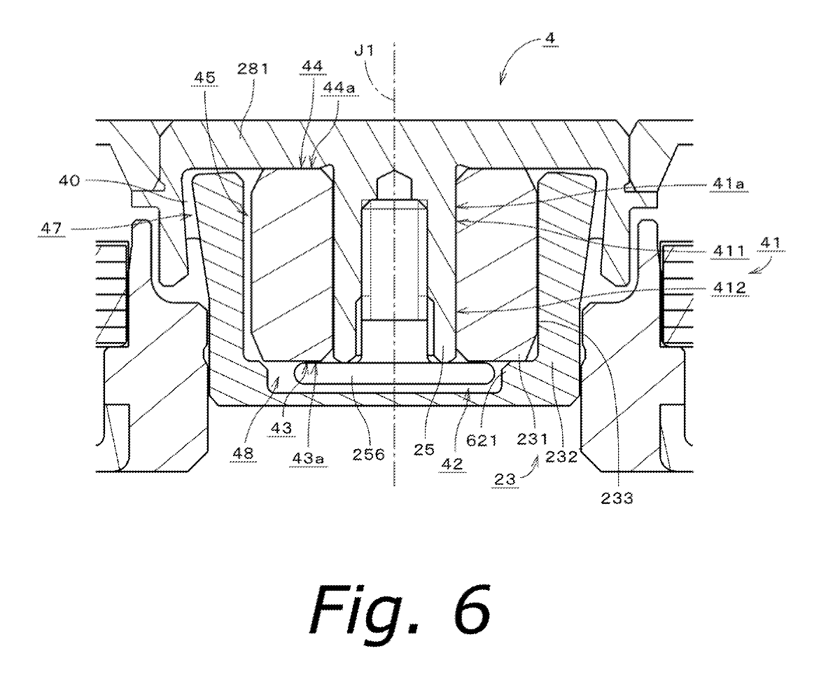

FIG. 6 is a vertical cross-sectional view of the bearing portion 23 and its vicinity. A lower gap 42 is defined between the plate portion 256 and the sleeve housing 232. The lubricating oil 40 is arranged in the lower gap 42. A plate surrounding space 48 is defined between a side surface of the plate portion 256 and an inside surface of a bottom portion of the sleeve housing 232. The lubricating oil 40 exists in the plate surrounding space 48. A second thrust gap 43 is defined between the lower surface of the sleeve 231 and the upper surface of the plate portion 256. The lubricating oil 40 is arranged in the second thrust gap 43. The second thrust gap 43 is arranged to define a second thrust dynamic pressure bearing portion 43a arranged to generate a fluid dynamic pressure in the lubricating oil 40. The plate surrounding space 48 enables the lubricating oil 40 to exist continuously from an outer circumferential portion of the second thrust gap 43 to an outer circumferential portion of the lower gap 42.

A radial gap 41 is defined between the outer circumferential surface of the shaft 251 and the inner circumferential surface of the sleeve 231. A lower end portion of the radial gap 41 is continuous with an inner circumferential portion of the second thrust gap 43. The radial gap 41 includes a first radial gap 411 and a second radial gap 412 arranged below the first radial gap 411.

The first radial gap 411 is defined between the outer circumferential surface of the shaft 251 and a portion of the inner circumferential surface of the sleeve 231 in which the first radial dynamic pressure groove array 272 illustrated in FIG. 3 is defined. Meanwhile, the second radial gap 412 is defined between the outer circumferential surface of the shaft 251 and a portion of the inner circumferential surface of the sleeve 231 in which the second radial dynamic pressure groove array 273 is defined. The lubricating oil 40 is arranged in the radial gap 41. The first and second radial gaps 411 and 412 are arranged to together define a radial dynamic pressure bearing portion 41a arranged to generate a fluid dynamic pressure in the lubricating oil 40. The shaft 251 is radially supported by the radial dynamic pressure bearing portion 41a.

A first thrust gap 44 is defined between an upper surface of the bearing portion 23 and the lower surface of the bearing opposing portion 281. The first thrust gap 44 is arranged to extend radially outward from an upper end portion of the radial gap 41. The lubricating oil 40 is arranged in the first thrust gap 44. A first thrust dynamic pressure bearing portion 44a arranged to generate a fluid dynamic pressure in the lubricating oil 40 is defined in a region of the first thrust gap 44 in which the first thrust dynamic pressure groove array 275 illustrated in FIG. 4 is defined. That is, a gap defined between the upper surface 274 of the sleeve 231 and the lower surface of the bearing opposing portion 281 is arranged to define the first thrust dynamic pressure bearing portion 44a arranged to generate the fluid dynamic pressure in the lubricating oil 40.

The bearing opposing portion 281 is axially supported by both the first and second thrust dynamic pressure bearing portions 44a and 43a. Provision of the first and second thrust dynamic pressure bearing portions 44a and 43a contributes to reducing a variation in vertical play of the shaft 251. The aforementioned seal gap 47 is arranged to extend downward from an outer circumferential portion of the first thrust gap 44.

Circulation channels 45 are defined between the outer circumferential surface of the sleeve 231 and the inner circumferential surface of the sleeve housing 232. Each circulation channel 45 is arranged to cause an outer circumferential portion of the first thrust dynamic pressure bearing portion 44a and an outer circumferential portion of the second thrust dynamic pressure bearing portion 43a to be in communication with each other.

In the motor portion 2, the seal gap 47, the first thrust gap 44, the radial gap 41, the second thrust gap 43, the plate surrounding space 48, the lower gap 42, and the circulation channels 45 are arranged to together define a single continuous bladder structure, and the lubricating oil 40 is arranged continuously in this bladder structure. Within the bladder structure, the surface of the lubricating oil 40 is defined only in the seal gap 47, which is located between the inner circumferential surface of the cylindrical seal portion 282 and the outer circumferential surface of the bearing portion 23. The bladder structure contributes to easily preventing a leakage of the lubricating oil 40.

The bearing mechanism 4 of the motor portion 2 includes the shaft 251, the sleeve 231, the sleeve housing 232, the adhesive 233, the plate portion 256, the bearing opposing portion 281, the cylindrical seal portion 282, and the aforementioned lubricating oil 40. In the bearing mechanism 4, the shaft 251, the plate portion 256, the bearing opposing portion 281, and the cylindrical seal portion 282 are arranged to rotate about the central axis J1 relative to the bearing portion 23 through the lubricating oil 40.

In the motor portion 2 illustrated in FIG. 1, a current is supplied to the stator 210 to produce a torque centered on the central axis J1 between the rotor magnet 262 and the stator 210. This causes the blades 31 of the impeller 3 to rotate about the central axis J1 together with the rotating portion 22. Rotation of the impeller 3 caused by the motor portion 2 causes an air to be drawn into the housing 5 through the air inlets 54 and sent out through the air outlet.

Regarding the blower fan 1, in the case where the central rotating portion 28 is defined by subjecting the metal to the cutting process, precision with which the central rotating portion 28 is shaped is improved. This enables each of the radial dynamic pressure bearing portion 41a, the first thrust dynamic pressure bearing portion 44a, the second thrust dynamic pressure bearing portion 43a, and the seal gap 47 to be defined with high precision. In the case where the cup portion 29 is made of the resin, a reduction in the weight of the rotating portion 22 is achieved. As a result, a reduction in the power consumption of the blower fan 1 is achieved.

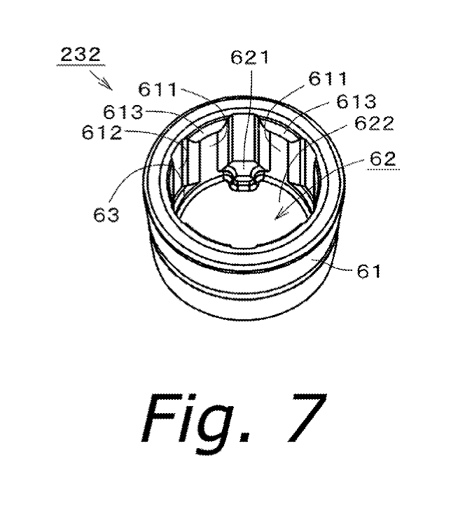

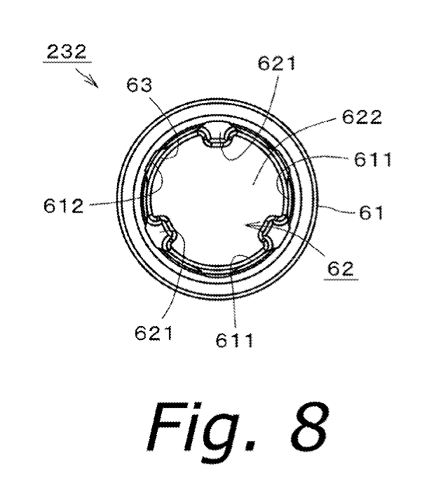

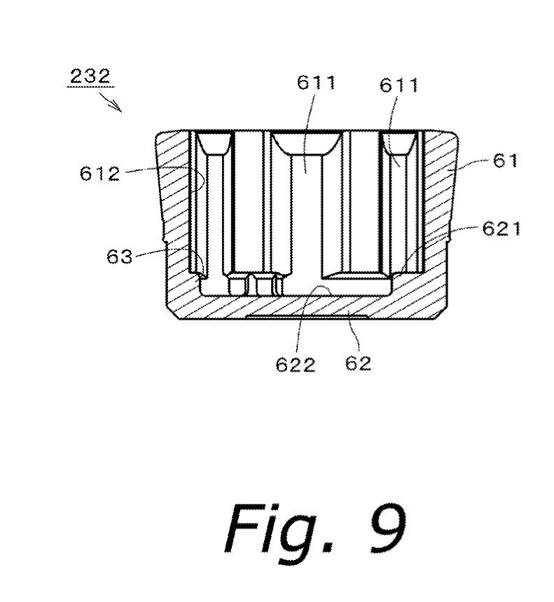

FIG. 7 is a perspective view of the sleeve housing 232. FIG. 8 is a plan view of the sleeve housing 232. FIG. 9 is a vertical cross-sectional view of the sleeve housing 232.

The sleeve housing 232 includes a cylindrical portion 61 and a bottom portion 62. The cylindrical portion 61 is substantially cylindrical. The bottom portion 62 is arranged to close a lower portion of the cylindrical portion 61. The cylindrical portion 61 is arranged to cover outer circumferences of the sleeve 231 and the plate portion 256. The bottom portion 62 includes a plurality of projecting portions 621. The projecting portions 621 are arranged in the circumferential direction in an upper surface 622 of the bottom portion 62. In FIG. 8, the number of projecting portions 621 is three. Each projecting portion 621 is arranged to project upward from the upper surface 622 of the bottom portion 62. As illustrated in FIG. 6, an upper end surface of each projecting portion 621 is arranged to be in contact with the lower surface of the sleeve 231. The distance between the upper surface 622 of the bottom portion 62 and the lower surface of the sleeve 231, that is, the height of a space arranged to accommodate the plate portion 256, is thereby determined. In addition, the plate portion 256 is arranged radially opposite each of the projecting portions 621. A space surrounded by the sleeve 231, the plate portion 256, and a lower portion of the sleeve housing 232 including the projecting portions 621 is the plate surrounding space 48.

The cylindrical portion 61 includes a plurality of contact portions 611. The contact portions 611 are arranged in the circumferential direction in an inner circumference of the cylindrical portion 61. Each contact portion 611 is arranged to extend in an axial direction. Each contact portion 611 is arranged to project radially inward in the inner circumference of the cylindrical portion 61. The contact portion 611 is arranged to be in contact with the outer circumferential surface of the sleeve 231. In FIG. 8, the contact portions 611 arranged in the circumferential direction are six in number, while the projecting portions 621, numbering three, are arranged in alternate locations between the contact portions 611. As illustrated in FIG. 7, an upper end of each contact portion 611 includes an inclined surface 613 arranged to be inclined upward with increasing distance from the central axis J1. This makes it easier to insert the sleeve 231 into the sleeve housing 232. Between the sleeve 231 and the sleeve housing 232, spaces are defined between the contact portions 611. Each of these spaces corresponds to one of the circulation channels 45 illustrated in FIG. 6.

As mentioned above, the sleeve 231 and the sleeve housing 232 are adhered to each other through the adhesive 233. That is, an adhesive layer is arranged to intervene between the sleeve 231 and each contact portion 611. The adhesive 233 is applied onto each contact portion 611 before the sleeve 231 is inserted into the sleeve housing 232. At least a portion of the adhesive 233 is arranged to exist between the outer circumferential surface of the sleeve 231 and an inner circumferential surface 612 of the cylindrical portion 61. The “inner circumferential surface 612” here refers to a surface of each contact portion 611 and inner surfaces of portions of the cylindrical portion 61 between the contact portions 611. Provision of the contact portions 611 contributes to improving strength with which the sleeve 231 and the sleeve housing 232 are adhered to each other. In the present preferred embodiment, a radially inner surface of each contact portion 611 is arranged to have a radius of curvature substantially the same as that of the outer circumferential surface of the sleeve 231. Note that the radially inner surface of the contact portion 611 may be flat or be arranged to project radially inward. Also note that the radially inner surface of the contact portion 611 may be a portion of a cylindrical surface having a radius of curvature greater than that of the outer circumferential surface of the sleeve 231.

Preferably, the sleeve 231 is inserted in the sleeve housing 232 while being press fitted thereto. Provision of the contact portions 611 spaced from one another makes it easier to press fit the sleeve 231 to the sleeve housing 232. Moreover, the press fitting of the sleeve 231 to the sleeve housing 232 is also made easier by the sleeve housing 232 being made of the resin. In the case where the sleeve housing 232 is made of the resin, a reduction in a production cost of the sleeve housing 232, which includes the projecting portions 621, is achieved. A gate mark resulting from molding of the sleeve housing 232 is located at a center of a lower surface of the bottom portion 62 of the sleeve housing 232.

Because the projecting portions 621 are spaced from one another in the circumferential direction, an adhesive held in a gap between the lower surface of the sleeve 231 and the upper end surface of any projecting portion 621 would enter into the space between the projecting portion 621 and an adjacent one of the projecting portions 621. Therefore, a reduction in a decrease in accuracy of the axial position of the sleeve 231 relative to the sleeve housing 232 is easily achieved compared to the case where a single annular projecting portion is provided instead of the projecting portions 621 spaced from one another in the circumferential direction. Moreover, management of a process when the sleeve 231 is inserted into the sleeve housing 232 is made easier. The contact portions 611 and the projecting portions 621 are arranged at different circumferential positions, and this contributes to preventing the adhesive from flowing into a gap above any projecting portion 621.

Furthermore, in the case where the single annular projecting portion is provided, there is a possibility that a superfluous adhesive will flow toward the plate portion 256. The bearing mechanism 4 illustrated in FIG. 6 is able to significantly reduce the probability that such a problem will occur. Prevention of inward entry of the adhesive is particularly suitable for a bearing mechanism in which any thrust dynamic pressure bearing portion is defined between the lower surface of the sleeve 231 and the upper surface of the plate portion 256.

Each projecting portion 621 is arranged to be radially continuous with the inner circumferential surface 612 of the cylindrical portion 61. That is, the projecting portion 621 is arranged to define a shoulder at a junction of the cylindrical portion 61 and the bottom portion 62. Both circumferential side portions of the projecting portion 621 are arranged to be continuous with the adjacent contact portions 611, while other portions of the projecting portion 621 are located in a region between the two contact portions 611. This results in improved flexural rigidity of the sleeve housing 232 at the junction of the cylindrical portion 61 and the bottom portion 62.

Meanwhile, the sleeve housing 232 further includes shoulder portions 63 independently of the projecting portions 621. Each shoulder portion 63 is located at a junction of the inner circumferential surface 612 of the cylindrical portion 61 and the upper surface 622 of the bottom portion 62. Each shoulder portion 63 is located circumferentially between adjacent ones of the contact portions 611. The shoulder portion 63 is arranged radially outward of a radially innermost position of each projecting portion 621. The shoulder portions 63 are arranged to extend in an annular shape in the circumferential direction except in regions where the contact portions 611 exist. The shoulder portions 63 may be considered to extend in a completely annular shape in the circumferential direction, because radially inner surfaces of the shoulder portions 63 and the radially inner surfaces of the contact portions 611 are arranged to be circumferentially continuous with one another. Note that an annular shoulder portion 63 extending in the circumferential direction may be provided, with a radially inner surface of the shoulder portion 63 being arranged radially inward of the radially inner surface of each contact portion 611. Each aforementioned shape of the shoulder portion(s) 63 makes it easy to manufacture a mold for molding the sleeve housing 232. The axial position of an upper surface of each shoulder portion 63 is arranged to be the same as that of an upper surface of each projecting portion 621. This also makes it easy to manufacture the mold for molding the sleeve housing 232.

Referring to FIG. 6, each shoulder portion 63 is arranged to be out of contact with the sleeve 231. This enables each circulation channel 45 to be in communication with the plate surrounding space 48. The circulation channels 45, the first thrust gap 44, the radial gap 41, and the second thrust gap 43 combine to enable circulation of the lubricating oil 40. The lubricating oil 40 may be arranged to circulate in any direction. The shoulder portions 63 contribute to improving the flexural rigidity of the sleeve housing 232 at the junction of the cylindrical portion 61 and the bottom portion 62 made of the resin while allowing the circulation of the lubricating oil 40.

Note that, regardless of presence or absence of the shoulder portions 63, a channel through which the lubricating oil 40 circulates is easily secured when the sleeve housing 232 is arranged to include no projecting portion 621 in at least one of the spaces circumferentially between the contact portions 611.

Referring to FIGS. 3 to 5, grooves 278 each of which is arranged to extend in the axial direction are defined in the outer circumferential surface of the sleeve 231. Each of the grooves 278 also defines a circulation channel arranged to cause the first and second thrust gaps 44 and 43 to be in communication with each other.

Referring to FIG. 6, an outer edge portion of a lower end of the sleeve 231 has a chamfered shape. This enables each shoulder portion 63 to be easily out of contact with the sleeve 231. This makes it possible to arrange the radial position of an outermost circumferential surface of a lower portion of the sleeve 231 to be the same as the radially innermost position of the shoulder portion 63, or to be radially outward of the radially innermost position of the shoulder portion 63. In addition, an increase in the radial width of the shoulder portion 63 is made possible. The “outermost circumferential surface of the lower portion” of the sleeve 231 here refers to an outermost circumferential surface of the lower portion of the sleeve 231 excluding the chamfer portion.

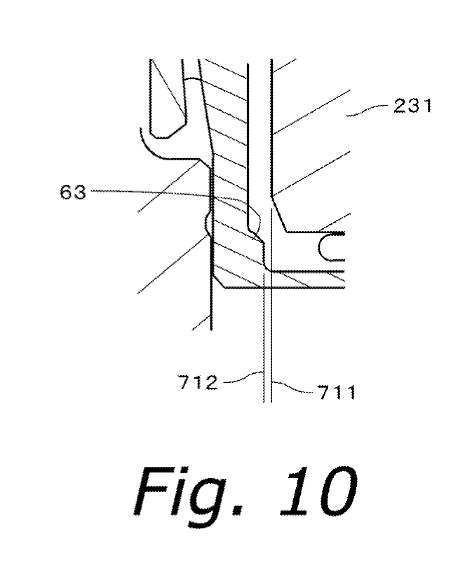

Needless to say, referring to FIG. 10, the radial position 711 of the outermost circumferential surface of the lower portion of the sleeve 231 may be arranged radially inward of the radially innermost position 712 of the shoulder portion 63 in order to ensure that the sleeve 231 and the shoulder portion 63 are out of contact with each other. Note that an outer edge portion of an upper end of the sleeve 231 also has a chamfered shape.

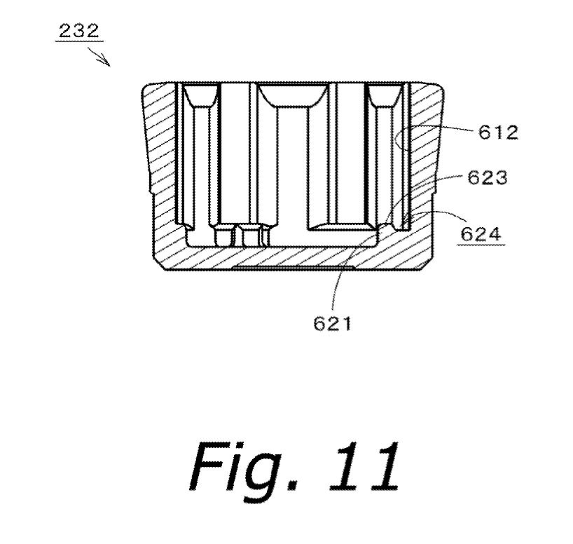

FIG. 11 is a vertical cross-sectional view of a sleeve housing 232 according to an example modification of the above-described preferred embodiment. In the sleeve housing 232 illustrated in FIG. 11, an upper end surface 623 of a projecting portion 621 is inwardly spaced from an inner circumferential surface 612 of the sleeve housing 232. The upper end surface 623 is a surface arranged to be in contact with a lower surface of a sleeve 231. In other words, a groove 624 extending in the circumferential direction is defined between the projecting portion 621 and the inner circumferential surface 612 of the sleeve housing 232. The groove 624 is arranged to cross a region between the projecting portion 621 and the inner circumferential surface 612 in the circumferential direction.

An adhesive that has protruded downward from a gap between the sleeve 231 and the sleeve housing 232 may enter into the groove 624, and this leads to an additional reduction in the probability that the adhesive will be adhered to the upper end surface 623 of the projecting portion 621. As a result, a reduction in a decrease in accuracy of the axial position of the sleeve 231 relative to the sleeve housing 232 is achieved.

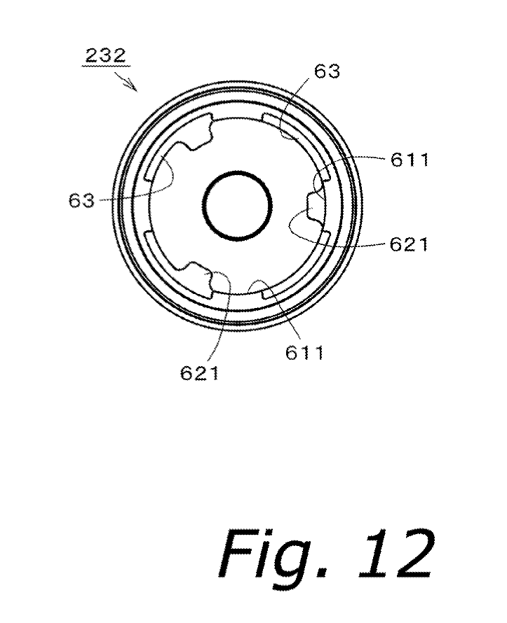

FIG. 12 is a plan view of a sleeve housing 232 according to another example modification of the above-described preferred embodiment. In the sleeve housing 232 illustrated in FIG. 12, the number of projecting portions 621 is three. Both the number of contact portions 611 and the number of shoulder portions 63 are four. The sleeve housing 232 illustrated in FIG. 12 is similar to the sleeve housing 232 illustrated in FIG. 8 except in the number of contact portions 611 and the number of shoulder portions 63.

Also in the sleeve housing 232 illustrated in FIG. 12, each shoulder portion 63 is located circumferentially between adjacent ones of the projecting portions 621. On the right-hand side in FIG. 12, one of the projecting portions 621 and one of the contact portions 611 are arranged at the same circumferential position. The circumferential position of each of the other two projecting portions 621 is arranged to overlap with the circumferential position of a separate one of the shoulder portions 63. The axial position of an upper end surface of each projecting portion 621 is arranged to be identical to the axial position of an upper end surface of each shoulder portion 63.

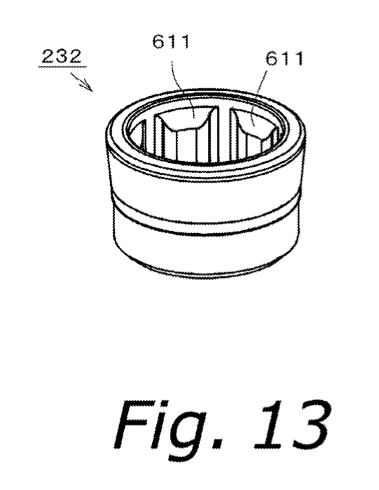

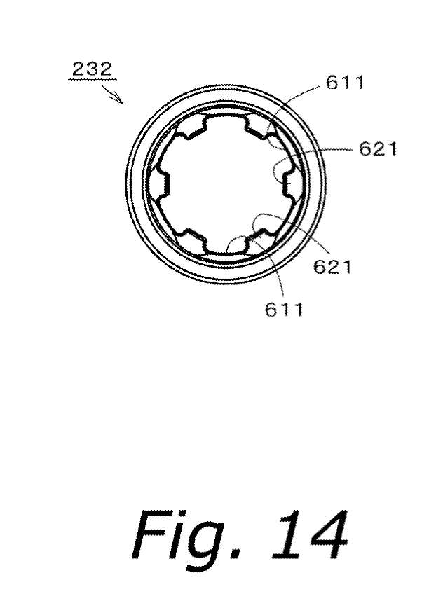

FIG. 13 is a perspective view of a sleeve housing 232 according to yet another example modification of the above-described preferred embodiment. FIG. 14 is a plan view of the sleeve housing 232. In the sleeve housing 232 illustrated in FIG. 14, the number of projecting portions 621 is six, and the number of contact portions 611 is also six. Each projecting portion 621 is located circumferentially between adjacent ones of the contact portions 611. This sleeve housing 232 includes no shoulder portion 63 as illustrated in FIG. 8. The sleeve housing 232 illustrated in FIGS. 13 and 14 are otherwise similar in structure to the sleeve housing 232 illustrated in FIG. 8.

Also in the sleeve housing 232 illustrated in FIGS. 13 and 14, a circulation channel 45 is defined between adjacent ones of the contact portions 611 between an outer circumferential surface of a sleeve 231 and an inner circumferential surface of the sleeve housing 232. Because the sleeve housing 232 includes no shoulder portion 63, the circulation channel 45 is arranged to be in communication with a plate surrounding space 48 through a gap defined between a chamfer portion of a lower portion of the sleeve 231 and a corresponding one of the projecting portions 621.

The structures of the bearing mechanism 4 and the blower fan 1 described above may be modified in a variety of manners.

For example, the number of grooves 278 defined in the outer circumferential surface of the sleeve 231 may be more than two. The grooves 278 are preferably arranged such that at least one of the grooves 278 never overlaps with any contact portion 611 when the sleeve 231 has been inserted in the sleeve housing 232. Also, the outer circumferential surface of the sleeve 231 may include no groove.

A material of any member of the bearing mechanism 4 may be changed appropriately. For example, the sleeve 231 may not necessarily be made of a sintered metal. The sleeve housing 232 may be made of a metal. For example, the sleeve housing 232 may be made of aluminum or the like, and be molded by die casting. The bushing 24 may also be made of a metal.

The contact portions 611 of the sleeve housing 232 may be omitted with the outer circumferential surface of the sleeve 231 including a plurality of ribs or grooves each of which is arranged to extend in the axial direction. No portion of the thrust dynamic pressure groove array may be defined in a region in an outer circumferential portion of the lower surface of the sleeve 231, the region being in contact with any projecting portion 621.

The first thrust dynamic pressure groove array 275 may be defined in an upper surface of the sleeve housing 232, or in a region opposed to the upper surface of the sleeve housing 232 in the lower surface of the bearing opposing portion 281. In other words, the first thrust dynamic pressure groove array 275 is defined in at least one of the upper surface of the bearing portion 23 and the lower surface of the bearing opposing portion 281. As a result, the first thrust dynamic pressure bearing portion 44a is defined between the upper surface of the bearing portion 23 and the lower surface of the bearing opposing portion 281.

The second thrust dynamic pressure bearing portion 43a may be omitted. In this case, the plate portion 256 only functions as a portion to prevent the shaft 251 from coming off the bearing portion 23. The first thrust dynamic pressure bearing portion 44a may also be omitted.

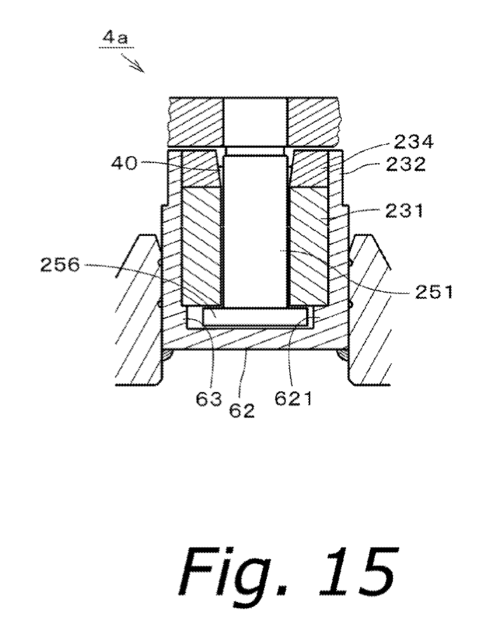

The surface of the lubricating oil 40 may be defined at a position different from the position according to the above-described preferred embodiment. FIG. 15 illustrates a bearing mechanism 4a according to an example modification of the above-described preferred embodiment. In the bearing mechanism 4a, a plurality of projecting portions 621 are arranged in a bottom portion 62 of a sleeve housing 232. The projecting portions 621 are arranged in the circumferential direction in an upper surface of the bottom portion 62. A shoulder portion 63 is arranged between adjacent ones of the projecting portions 621 as necessary. The bearing mechanism 4a illustrated in FIG. 15 includes no circulation channel. An adhesive is used to fix a sleeve 231 to the sleeve housing 232. A seal cap 234 is arranged above the sleeve 231. The seal cap 234 is fixed to an inner circumferential surface of an upper portion of the sleeve housing 232. A surface of a lubricating oil 40 is defined between an outer circumferential surface of a shaft 251 and an inner circumferential surface of the seal cap 234. The bearing mechanism 4a is substantially similar to the bearing mechanism 4 illustrated in FIG. 2 in a structure in the vicinity of a plate portion 256. A thrust dynamic pressure bearing portion may be defined between a lower surface of the plate portion 256 and an inner bottom surface of the sleeve housing 232.

In each of the bearing mechanism 4 illustrated in FIG. 2 and the bearing mechanism 4a illustrated in FIG. 15, the lubricating oil 40 is arranged to exist continuously in a gap between a portion including the sleeve 231 and the sleeve housing 232 and a portion including the shaft 251 and the plate portion 256. In the case where the lubricating oil 40 is arranged to circulate as in the bearing mechanism 4 illustrated in FIG. 2, the lubricating oil 40 is arranged to exist continuously from the plate surrounding space 48, which is a space surrounding the plate portion 256, to the radial dynamic pressure bearing portion 41a through each circulation channel 45 and the upper surface of the sleeve 231, and then to exist continuously from the radial dynamic pressure bearing portion 41a to the plate surrounding space 48 through the lower surface of the sleeve 231. Needless to say, as mentioned above, the ribs or grooves may be defined in the outer circumferential surface of the sleeve 231 in place of the circulation channels 45.

In the blower fan 1, only one of the upper and lower plates 51 and 52 may include the air inlet 54. A blower fan in which the bearing mechanism 4 is provided may be an axial fan. The bearing mechanism 4 may be used in a motor used for another purpose.

Features of the above-described preferred embodiments and the modifications thereof may be combined appropriately as long as no conflict arises.

Bearing mechanisms according to preferred embodiments of the present invention may be used in a variety of applications. Preferably, bearing mechanisms according to preferred embodiments of the present invention are used in motors used for a variety of purposes.

What is claimed is:

1. A bearing mechanism comprising:
a shaft arranged to have a central axis extending in a vertical direction as a center thereof;
a sleeve in which the shaft is inserted;
a plate portion in a shape of a disk, arranged to extend radially outward from a lower end of the shaft, arranged opposite to a lower surface of the sleeve, and arranged to have a diameter smaller than that of the lower surface of the sleeve;
a sleeve housing inside which the sleeve and the plate portion are arranged;
an adhesive arranged to adhere the sleeve and the sleeve housing to each other; and
a lubricating oil; wherein
the sleeve housing includes:
a cylindrical portion arranged to cover outer circumferences of the sleeve and the plate portion; and
a bottom portion arranged to close a lower portion of the cylindrical portion;
the bottom portion includes a plurality of projecting portions arranged in a circumferential direction in an upper surface of the bottom portion, each projecting portion being arranged to project upward to be in contact with the lower surface of the sleeve;
each of the projecting portions and the plate portion are arranged radially opposite each other;
at least a portion of the adhesive is arranged to exist between an outer circumferential surface of the sleeve and an inner circumferential surface of the cylindrical portion;
the lubricating oil is arranged to exist continuously in a gap between a portion including the sleeve and the sleeve housing and a portion including the shaft and the plate portion; and
the shaft and the sleeve are arranged to have a radial dynamic pressure bearing portion defined therebetween.

2. The bearing mechanism according to claim 1, wherein each of the projecting portions is arranged to be radially continuous with the inner circumferential surface of the cylindrical portion of the sleeve housing.

3. The bearing mechanism according to claim 1, wherein an upper end surface of each of the projecting portions, the upper end surface being in contact with the sleeve, is spaced from the inner circumferential surface of the cylindrical portion of the sleeve housing.

4. The bearing mechanism according to claim 1, wherein the cylindrical portion includes a plurality of contact portions arranged in the circumferential direction in an inner circumference thereof, each contact portion being arranged to extend in an axial direction and to be in contact with the outer circumferential surface of the sleeve.

5. The bearing mechanism according to claim 4, wherein the sleeve is inserted in the sleeve housing while being press fitted thereto.

6. The bearing mechanism according to claim 4, wherein the lubricating oil is arranged to exist continuously from a space surrounding the plate portion to a space between adjacent ones of the contact portions between the sleeve and the sleeve housing, and then to exist continuously from the space between the adjacent contact portions to the radial dynamic pressure bearing portion through an upper surface of the sleeve.

7. The bearing mechanism according to claim 6, wherein no projecting portion is arranged to exist in at least one space circumferentially between adjacent ones of the contact portions.

8. The bearing mechanism according to claim 6, wherein
the sleeve housing further includes a shoulder portion at a junction of the inner circumferential surface of the cylindrical portion and the upper surface of the bottom portion;
the shoulder portion is arranged radially outward of a radially innermost position of each of the projecting portions; and
the shoulder portion is arranged to be out of contact with the sleeve.

9. The bearing mechanism according to claim 8, wherein
an outer edge portion of a lower end of the sleeve is arranged to have a chamfered shape; and
a radial position of an outermost circumferential surface of a lower portion of the sleeve is arranged to be the same as a radially innermost position of the shoulder portion, or to be radially outward of the radially innermost position of the shoulder portion.

10. The bearing mechanism according to claim 8, wherein a radial position of an outermost circumferential surface of a lower portion of the sleeve is arranged radially inward of a radially innermost position of the shoulder portion.

11. The bearing mechanism according to claim 1, wherein the lower surface of the sleeve and an upper surface of the plate portion are arranged to have a thrust dynamic pressure bearing portion defined therebetween.

12. The bearing mechanism according to claim 1, wherein the sleeve housing is made of a resin.

13. A blower fan comprising:
a plurality of blades arranged in a circumferential direction about a central axis extending in a vertical direction; and
a motor portion arranged to rotate the blades about the central axis; wherein the motor portion includes:
a stationary portion;
the bearing mechanism of claim 1; and
a rotating portion to which the blades are fixed, and supported by the bearing mechanism to be rotatable with respect to the stationary portion.
